(19) United States
(12) Patent Application Publication
(10) Pub. No.: US 2023/0352959 A1
(43) Pub. Date: Nov. 2, 2023

(54) ENERGY CONVERSION MANAGEMENT SYSTEM AND METHOD

(71) Applicant: FranklinWH Energy Storage Inc., SAN JOSE, CA (US)

(72) Inventors: Daqing WANG, Shenzhen (CN); Haisheng SONG, Shenzhen (CN); Yuezhen HU, Shenzhen (CN); Gang XIAO, Shenzhen (CN); Rongrong YANG, Shenzhen (CN)

(21) Appl. No.: 18/348,921

(22) Filed: Jul. 7, 2023

Related U.S. Application Data
(63) Continuation of application No. PCT/CN2021/135334, filed on Dec. 3, 2021.

(30) Foreign Application Priority Data
Aug. 12, 2021 (CN) 202110923404.8

(51) Int. Cl. H02J 7/00; H02J 3/32

(52) U.S. Cl. CPC H02J 7/00712; H02J 7/00036; H02J 7/007188; H02J 3/32; H02J 3/381

(57) ABSTRACT

Provided are an energy conversion management system and method. The energy conversion management system includes a battery module, a battery management module, a power control module, and a telemetry terminal connected to the battery management module and the power control module respectively. The battery management module is configured to perform information acquisition, control and data management on the battery module, transmit battery information to the telemetry terminal, and receive the feedback information from the telemetry terminal. The power control module is configured to control the charging power and discharging power of the battery module according to the control instruction of the battery management module and the control instruction of the telemetry terminal. The telemetry terminal is configured to perform data interaction with a user and control the battery management module and the power control module according to a user instruction.

### CROSS-REFERENCE TO RELATED APPLICATIONS

This application is a continuation application of International Patent Application No. PCT/CN2021/135334, filed on Dec. 3, 2021, which claims the priority to Chinese Patent Application No. 202110923404.8, filed on Aug. 12, 2021, the content of all of which is incorporated herein by reference in their entirety.

### TECHNICAL FIELD

Embodiments of the present disclosure relate to new energy management technology and, in particular, to an energy conversion management system and method.

### BACKGROUND

In recent years, with the emphasis on climate change and the promotion of the government and other factors, the new energy industry develops rapidly. The proportion of new energy in the energy structure also rises rapidly. The new energy plays an important role in adjusting the energy structure, reducing greenhouse gas emissions, and promoting the development of strategic emerging industries. Most of the usage scenarios of the new energy involve energy storage and energy conversion, and thus batteries become even more important.

However, the intelligent control, power conversion, and uniform scheduling of the existing battery energy storage schemes and existing battery energy conversion schemes are not ideal, and there are fewer application scenarios for battery energy storage modules.

### SUMMARY

The present disclosure provides an energy conversion management system and method. The intelligent degree of the energy conversion management system is improved, and the conversion power is flexibly adjusted according to different power consumption conditions to implement an optimal economic benefit effect.

In a first aspect, an embodiment of the present disclosure provides an energy conversion management system. The system includes a battery module, a battery management module, a power control module, and at least one telemetry terminal.

The battery module is connected to the battery management module. The battery module is configured to store electric energy and supply power to a load.

The battery management module is connected to the power control module and the telemetry terminal. The battery management module is configured to perform information acquisition, control, and data management on the battery module, transmit battery information to the telemetry terminal and/or the power control module, and simultaneously receive the feedback information of the telemetry terminal and/or the power control module.

The power control module is connected to the telemetry terminal. The power control module is configured to control the charging power and discharging power of the battery module according to the battery information transmitted by the battery management module and a control instruction from the telemetry terminal.

The telemetry terminal is configured to perform data interaction with a user and control the battery management module and the power control module according to a user instruction.

Optionally, the system also includes an energy control module. The energy control module is connected to the battery management module, the power control module, a user load, and a power supply. The energy control module is configured to choose and connect the user load and/or the power supply according to the battery information transmitted by the battery management module and the state of the battery management module.

Optionally, the battery management module includes an information acquisition unit, a control unit, and a data management unit.

The information acquisition unit is configured to acquire voltage information, temperature information, and current information of the battery module.

The control unit is configured to control charging and discharging of the battery module according to a preset determination condition.

The data management unit is configured to count the number of charging and discharging cycles of the battery module and the charging and discharging electric quantity of the battery module.

Optionally, the control unit is configured to control the charging and discharging of the battery module according to the preset determination condition in the manners including: the control unit acquires the state information of the battery module, and determines whether the function of the battery module is normal according to the state information, and sends a determination result to the power control module; when the function of the battery module is normal, the control unit turns on the charging and discharging circuit of the battery module.

Optionally, the energy control module is configured to: when a supply of the power supply is greater than the user load, send a control instruction to the power control module. The power control module is configured to control the power supply to charge the battery module according to the control instruction from the energy control module.

The energy control module is configured to: when the supply of the power supply is less than the user load, according to the relationship between the current electricity price queried by the energy control module and a first threshold, control a battery module and/or the power supply to supply power to the user load and controls the power supply to charge the battery module.

Optionally, the energy control module is also configured to control the battery module to feed power to the power supply according to a user instruction received by the telemetry terminal.

Optionally, the power control module includes a DC/DC converter and a DC/AC converter.

The DC/AC converter is configured to: when the battery module is charged to store electric energy, convert an alternating current supplied by the power supply into a direct current and transfer the direct current to the DC/DC converter; and the DC/DC converter is configured to buck the direct current and transfer the bucked direct current to the battery module.

The DC/AC converter is configured to: when the battery module supplies power to the load, boost a direct current output by the battery module and transfer the boosted direct current to the DC/AC converter, and the DC/AC converter is configured to convert the boosted direct current into an alternating current and transfer the alternating current to the user load.

Optionally, the system also includes a wireless module. The energy control module is connected to the telemetry terminal through the wireless module. The wireless module is configured to wirelessly receive the user instructions.

Optionally, the battery module includes a single battery or multiple battery packs connected in parallel.

In a second aspect, an embodiment of the present disclosure provides an energy conversion management method. The method is applied to the energy conversion management system described in the first aspect. The method includes: acquiring battery module information, current electricity price information, user load information, and power supply information; determining a relationship between a supply of the power supply and a user load and a relationship between a current electricity price and a first threshold; and controlling charging or discharging of the battery module according to a determination result.

In the present disclosure, the battery module, the battery management module, and the power control module are electrically connected in sequence. The management module and the power control module are connected to the telemetry terminal respectively. The battery management module controls the battery module and the power control module according to acquired information and/or the instruction input by the user through the telemetry terminal. The power control module controls the charging power and discharging power of the battery module according to the instruction of the battery management module. In this manner, the following Problems are solved: the intelligent control, power conversion, and uniform scheduling of battery energy storage schemes and battery energy conversion schemes are not ideal, and there are fewer application scenarios for battery energy storage modules. Moreover, the intelligent degree of the energy conversion management system is improved, and the conversion power may be flexibly adjusted according to different power consumption conditions to implement an optimal economic benefit effect.

### BRIEF DESCRIPTION OF DRAWINGS

FIG. 1 is a diagram illustrating the structure of an energy conversion management system according to embodiment one of the present disclosure.

FIG. 2 is a diagram illustrating the structure of another energy conversion management system according to embodiment one of the present disclosure.

FIG. 3 is a diagram illustrating the structure of another energy conversion management system according to embodiment one of the present disclosure.

FIG. 4 is a diagram illustrating the structure of another energy conversion management system according to embodiment one of the present disclosure.

FIG. 5 is a flowchart of an energy conversion management method according to embodiment two of the present disclosure.

### DETAILED DESCRIPTION

The present disclosure is further described hereinafter in detail in conjunction with drawings and embodiments. It is to be understood that the embodiments described herein are merely intended to explain the present disclosure but not to limit the present disclosure. Additionally, it is to be noted that for ease of description, only part, not all, of the structures related to the present disclosure are illustrated in the drawings.

### Embodiment One

FIG. 1 is a diagram illustrating the structure of an energy conversion management system according to embodiment one of the present disclosure.

The proportion of new energy in the energy structure rises rapidly, and the new energy gradually approaches people's lives. In municipal engineering, for example, a street lamp is mounted with a photovoltaic panel and/or a fan, and solar energy and/or wind energy is used for generating electricity for the street lamp. In the embodiment where the generated electricity is sufficient for the street lamp, redundant electric quantity of the generated electricity may be transmitted to a power grid for use by other users. The photovoltaic panel and the fan are uniformly managed by the municipal department. When the new energy is applied to a residential quarter, for example, a photovoltaic panel and/or a fan is mounted on a roof, the generated clean energy may be applied to the public facility of the quarter and may also be applied to household appliances in each household. The energy conversion management system according to this embodiment of the present disclosure uses electric energy generated from the clean energy for household appliance devices and may be individually controlled by each household.

As shown in FIG. 1, an energy conversion management system includes a battery module 100, a battery management module 200, a power control module 300, and at least one telemetry terminal 400.

The battery module 100 is connected to the battery management module 200. The battery module 100 is configured to store electric energy and supply power to a load.

Optionally, the battery module 100 is a storage battery. The battery module 100 includes a single battery or multiple battery packs connected in parallel. The multiple battery packs connected in parallel are used for increasing the battery capacity of the battery module 100. In a preset condition, the battery module 100 may store electric energy or supply power to a user load.

The battery management module 200 is connected to the power control module 300 and the telemetry terminal 400. The battery management module 200 is configured to perform information acquisition, control, and data management on the battery module 100, send battery information to the telemetry terminal 400 and/or the power control module 300, and simultaneously receive the feedback information from the telemetry terminal 400 and/or the power control module 300.

The battery management module 200 performs information acquisition, state monitoring, and data management on the battery module 100. The battery management module 200 sends the acquired information and the monitored state to the power control module 300 and receives the instruction from the power control module 300 or the instruction input by a user through the telemetry terminal 400. When the battery module 100 is in a charging and discharging state, the battery management module 200 performs controlling on the on state of the charging and discharging circuit of the battery module 100. If the battery module 100 is not in the charging and discharging state, the battery management module 200 performs information feedback. The battery management module 200 is connected to the telemetry terminal 400. When the battery management module 200 performs information acquisition, state monitoring, and data management on the battery module 100, the battery management module 200 sends the battery information to the telemetry terminal 400 in time. The user may monitor the operation of the battery module through the telemetry terminal 400, and the user may perform feedback on the battery management module 200 through the telemetry terminal 400 at the same time.

The power control module 300 is connected to the telemetry terminal 400. The power control module 300 is configured to control the charging power and discharging power of the battery module 100 according to the battery information transmitted by the battery management module 200 and the control instruction from the telemetry terminal 400.

The power control module 300 may receive the battery information transmitted by the battery management module 200 and the control instruction input by the user, and control the battery module 100 to provide electric energy according to the power required by the user load according to the control instruction, or convert the alternating current provided by an external power supply into a direct current, and charge the battery module 100 according to the charging power required by the battery module 100.

The telemetry terminal 400 is configured to perform data interaction with the user and control the battery management module 200 and the power control module 300 according to the user instruction.

The telemetry terminal 400 is connected to the battery management module 200 and the power control module 300 through a communication bus, such as a CAN bus or an RS485 communication cable. The telemetry terminal 400 receives the feedback information from the battery management module 200 and the feedback information from the power control module 300 for data interaction with the user, and also can generate a control instruction to control the battery management module 200 and the power control module 300 according to user operations.

In the present disclosure, the battery module, the battery management module, and the power control module are electrically connected in sequence. The battery management module and the power control module are connected to the telemetry terminal respectively. The battery management module controls the battery module and the power control module according to acquired information and/or the instruction input by the user through the telemetry terminal. The power control module controls the charging power and discharging power of the battery module according to the instruction from the battery management module. And thus the following problems are solved: the intelligent control, power conversion, and uniform scheduling of battery energy storage schemes and battery energy conversion schemes are not ideal, and there are fewer application scenarios for battery energy storage modules. The intelligent degree of the energy conversion management system is improved, and the conversion power is flexibly adjusted according to different power consumption conditions to implement an optimal economic benefit effect.

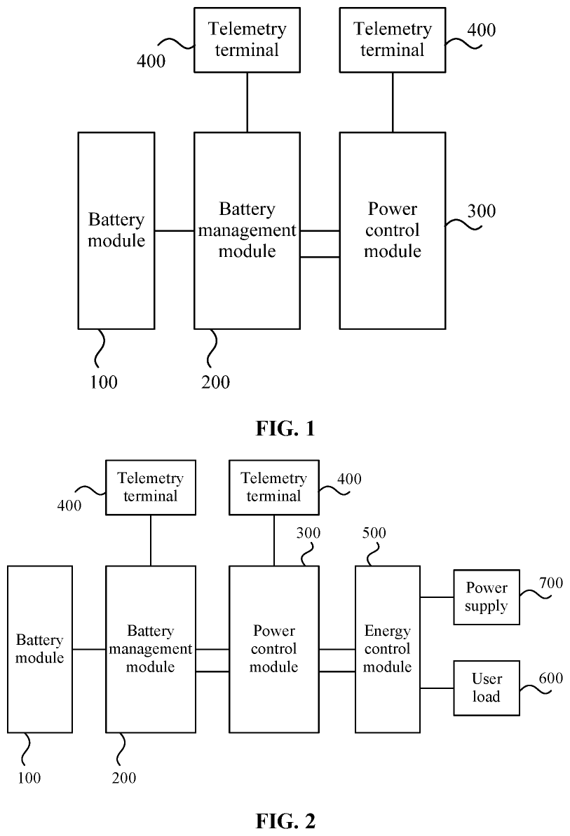

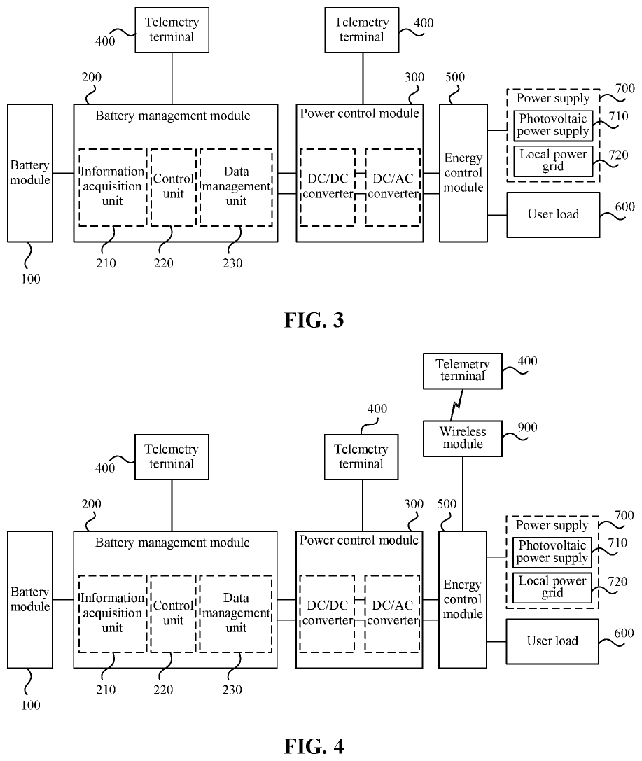

On the basis of the preceding technical solutions, as shown in FIG. 2, optionally, the energy conversion management system further includes an energy control module 500. The energy control module 500 is connected to the battery management module 200, the power control module 300, the user load 600, and a power supply 700. The energy control module 500 is configured to choose and connect the user load 600, the battery module 100, and/or the power supply 700 according to the battery information transmitted by the battery management module 200 and the state of the battery management module 200.

The energy control module 500 generates a control instruction according to the information and state of the battery module 100 transmitted by the battery management module 200 and the relationship between the power supply 700, the user load 600, and a pre-stored electricity price. The control instruction includes a connection instruction and a charging and discharging instruction. The energy control module 500 chooses and connects the user load 600, the battery module 100, and/or the power supply 700 according to the connection instruction and chooses one or more of the battery module 100 and/or the power supply 700 to supply power to the user load 600. The charging and discharging instruction is transmitted to the power control module 300 and forwarded to the battery management module 200. The power control module 300 charges and discharges the power of the battery module 100 according to the charging and discharging instruction. The battery management module 200 turns on the charging and discharging circuit of the battery module 100 according to the state of the battery module 100 or the charging and discharging instruction.

Optionally, the power supply 700 may be green energy available for personal use and the electric energy of a local power grid, such as a photovoltaic power supply and a wind energy power supply. The photovoltaic power supply is used in this embodiment for description.

On the basis of the preceding technical solutions, as shown in FIG. 3, optionally, the power control module 300 includes a DC/DC converter 320 and a DC/AC converter 310.

When the battery module 100 is charged to store electric energy, the DC/AC converter 310 is configured to convert an alternating current supplied by the power supply 700 into a direct current and transfer the direct current to the DC/DC converter 320. The DC/DC converter 320 is configured to buck the direct current and transfer the direct current to the battery module 100.

When the battery module 100 supplies power to the load, the DC/DC converter 320 is configured to boost the direct current output by the battery module and transfer the direct current to the DC/AC converter 310. The DC/AC converter 310 is configured to convert the boosted direct current into an alternating current and transfer the alternating current to the user load 600.

Optionally, the DC/DC converter 320 and the DC/AC converter 310 use dual-core chips. A dual-core peripheral resource may be freely allocated. Control architecture is more flexible. The interaction speed of dual-core data is high. Shared memory data is used for exchanging. In this manner, the speed and reliability of communication are improved, and higher-performance algorithms are run, thereby improving the control accuracy and speed of the energy conversion management system.

Optionally, with continued reference to FIG. 3, the battery management module 200 includes an information acquisition unit 210, a control unit 220, and a data management unit 230.

The information acquisition unit 210 is configured to acquire voltage information, temperature information, and current information of the battery module 100.

The control unit 220 is configured to control charging and discharging of the battery module 100 according to a preset determination condition.

The data management unit 230 is configured to count the number of charging and discharging cycles of the battery module 100 and the charging and discharging electric quantity of the battery module 100.

Optionally, the control unit 220 controls the charging and discharging of the battery module 100 according to the preset determination condition in the manner: the control unit 220 acquires the state information of the battery module 100; and the control unit 220 determines whether the function of the battery module 100 is normal according to the state information and sends the determination result to the power control module 300; and the control unit 220 turns on the charging and discharging circuit of the battery module 100 when the function of the battery module 100 is normal.

Optionally, when a supply of the power supply 700 is greater than the user load 600, the energy control module 500 sends a control instruction to the power control module 300. The power control module 300 controls the power supply 700 to charge the battery module 100.

When a supply of the power supply 700 is less than the user load 600, according to the relationship between the current electricity price queried by the energy control module 500 and a first threshold, the energy control module controls a battery module 100 and/or the power supply 700 to supply power to the user load and controls the power supply 700 to charge the battery module 100.

For example, as shown in FIG. 3, the power supply 700 includes a photovoltaic power supply 710 and a local power grid 720. When the power supply of the photovoltaic power supply 710 is greater than the power required by the user load 600, the energy control module 500 connects the photovoltaic power supply 710 to the user load 600 and the energy conversion management system respectively, so that the photovoltaic power supply 710 supplies power to the user load 600. If the control unit determines that the function of the battery module is normal according to the state information of the battery module 100, that is, when the battery may normally be charged and discharge, the redundant electric energy of the photovoltaic power supply 710 is converted to a direct current through the DC/AC converter 310 in the power control module 300 and the direct current is transferred to the DC/DC converter 320. The DC/DC converter 320 bucks the direct current to satisfy the charging standard of the battery module 100 and then transfers the direct current to the battery module 100 for charging. At the same time, the information acquisition unit in the battery management module 200 acquires the voltage information, the temperature information, and the current information of the battery module 100 and performs over-voltage protection, over-temperature protection, and over-current protection on the battery module 100. The data management unit counts charging electric quantity. After the battery module 100 is fully charged, charging is disconnected in time to perform overcharge protection on the battery module 100. While the photovoltaic power supply 710 is sufficient to charge the battery module 100, if the local power grid policy permits, the redundant electric energy of the photovoltaic power supply 710 is fed back to the local power grid 720 through configuration by the user. When the power supply of the photovoltaic power supply 710 is insufficient to bear the power of the user load 600 and the charging power of the battery module 100 at the same time, the power of the user load 600 is satisfied first, and the charging power of the battery module 100 is satisfied second.

If the power supply of the photovoltaic power supply 710 is insufficient to bear the user load 600, the energy control module 500 sends the control instruction to the power control module to control the battery module 100 to supply power to the user load 600. If the combined power supply of the photovoltaic power supply 710 and the battery module 100 is insufficient to satisfy the user load 600, the energy control module 500 is connected to the local power grid 720 at the same time to supply power to the user load 600.

The energy control module 500 may query the local electricity price in real time and choose the battery module 100 and/or the power supply 700 to supply power to the user load to produce good economic benefits. For example, when the power supply of the photovoltaic power supply is less than the user load 600, and the current electricity price is less than the first threshold, in order to optimize the economic benefits of photovoltaic power generation, the system is controlled to access the local power grid 720 for power supply to satisfy the requirement of the user load 600. At the same time, the electric energy of the photovoltaic power supply 710 is used for charging the battery module 100. If the current electricity price is greater than or equal to the first threshold, and the electricity price is higher, and generally, corresponding to the peak period of electricity consumption, in order to reduce the load of the local power grid 720 and reduce the electricity expense of the user, the battery module 100 is preferentially controlled to discharge to satisfy the requirement of the user load 600. If the requirement of the user load 600 cannot be satisfied, the local power grid 720 is accessed to supply power to the user load 600.

Optionally, when there is no photovoltaic power generation, the local power grid 720 supplies power to the user load 600. If the battery module 100 lacks electricity, the local power grid 720 is used to charge the battery module 100 to prolong the service life of the battery module 100.

Optionally, the energy control module is further configured to control the battery module to feed power to the power supply according to the user instruction received by the telemetry terminal.

When a power grid has a power feeding requirement, the battery module 100 may also directly feed power to the power grid.

The energy control module 500 intelligently manages the power supply of the photovoltaic power supply 710 and the power supply of the local power grid 720, and the charging and discharging energy conversion between the user load 600 and the battery module 100 according to the power supply of the photovoltaic power supply 710 and the relationship between the current electricity price and the first threshold. In this manner, the user can have better economic benefits when using the energy conversion management system.

As shown in FIG. 4, optionally, the energy conversion management system further includes a wireless module 900. The wireless module 900 is connected to the telemetry terminal 400 and configured to wirelessly receive the user instruction.

As an example, the user may wirelessly connect to the energy control module 500 through a mobile phone, which is convenient for the user to control the energy conversion management system.

Optionally, the energy conversion management system in this embodiment may be used in parallel with multiple systems, and the energy conversion management system and the multiple systems are controlled by the same telemetry terminal 400. The energy conversion management system in this embodiment may support up to 15 systems connected in parallel. A parallel operation can improve the uniform scheduling of multiple overall systems and maximize the economic benefits of energy conversion in a certain area.

### Embodiment Two

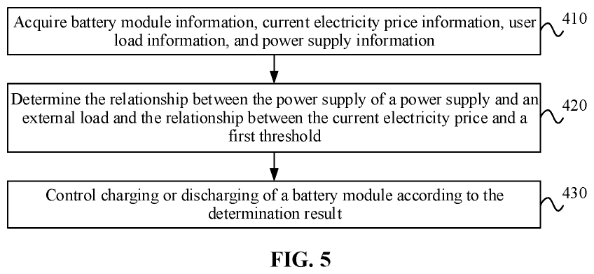

FIG. 5 is a flowchart of an energy conversion management method according to embodiment two of the present disclosure. This embodiment is applicable to the energy storage and conversion management of clean energy in a household or a small area. This method may be executed by the energy conversion management system. The method includes the steps below.

In step 410, the battery module information, current electricity price information, user load information, and power supply information are acquired.

The battery management module serve as a processing control module and stores a preset program, performs information acquisition, state monitoring, and data management on the battery module, generates the control instruction based on the acquired information or the instruction input by the user through the telemetry terminal, and controls the battery module and the power control module.

In step 420, the relationship between a supply of the power supply and the user load is determined, and the relationship between the current electricity price and the first threshold is determined.

The step 420 specifically includes the steps below.

In step 421, the relationship between a supply of the power supply and the user load is determined. If the supply of the power supply is greater than or equal to the user load, the power supply is controlled to charge the battery module. If the supply of the power supply is less than the user load, step 422 is executed.

As an example, the power supply in this embodiment is a photovoltaic power supply. When the power supply of the photovoltaic power supply is greater than the power required by the user load, the energy control module connects the photovoltaic power supply to the user load and the energy conversion management system respectively. The photovoltaic power supply supplies power to the user load. If the control unit determines that the function of the battery module is normal according to the state information of the battery module 100, that is, when the battery may be normally charged, the redundant alternating current provided by the photovoltaic power supply is converted into a direct current by the power control module, and the direct current is bucked to satisfy the charging standard of the battery module and then transmitted to the battery module for charging. At the same time, the battery management module performs over-voltage protection, over-temperature protection, and over-current protection on the battery module, counts charging electric quantity, disconnects charging in time after the battery module is fully charged, and performs overcharge protection on the battery module. While the supply of the photovoltaic power supply is sufficient to charge the battery module, if the local power grid policy permits, the redundant electric energy of the photovoltaic power supply is fed back to the local power grid 720 through configuration by the user.

When the power supply of the photovoltaic power supply is insufficient to bear the user load and the charging power of the battery module at the same time, the power of the user load is satisfied first, and the charging power of the battery module is satisfied second.

In step 422, the relationship between the current electricity price and the first threshold is determined.

The energy control module may query the local electricity price sheet in real time. When the power supply of the photovoltaic power supply is less than the user load, according to the relationship between the current electricity price queried by the energy control module and the first threshold, in the embodiment where the user load is satisfied, the energy conversion management method having optimal economic benefits is chosen.

In step 430, the charging or discharging of the battery module is controlled according to the determination result.

The step 430 specifically includes the steps below.

In step 431, if the current electricity price is less than the first threshold, the system is controlled to access the local power grid for power supply to satisfy the requirement of the user load. At the same time, the power supply of the photovoltaic power supply is used for charging the battery module.

In step 432, if the current electricity price is greater than or equal to the first threshold, the battery module is controlled to supply power to the user load.

If the current electricity price is greater than or equal to the first threshold, and the economic value is considered, the economic value of using a power grid to supply power to the user load is low, the battery module is preferentially controlled to discharge to satisfy the user load requirement. If the user load requirement cannot be satisfied, the local power grid is accessed to supply power to the user load.

In the present disclosure, the battery module, the battery management module, and the power control module are electrically connected in sequence. The battery management module and the power control module are connected to the telemetry terminal respectively. The battery management module controls the battery module and the power control module according to acquired information and/or the instructions input by the user through the telemetry terminal. The power control module controls the charging power and discharging power of the battery module according to the instructions of the battery management module. In this manner, the following problems are solved: the intelligent control, power conversion, and uniform scheduling of battery energy storage schemes and battery energy conversion schemes are not ideal, and there are fewer application scenarios for battery energy storage modules. Moreover, the intelligent degree of the energy conversion management system is improved, and the conversion power may be flexibly adjusted according to different power consumption conditions.

Optionally, the energy control module controls the battery module to feed power to the power supply according to instructions input by the telemetry terminal.

When a power grid has a power feeding requirement, the battery module may also directly feed power to the local power grid.

When the energy conversion management system of the preceding technical solutions is used, it is possible to simultaneously satisfy a user load requirement and enable clean energy to produce good economic benefits.

It is to be noted that the preceding are only preferred embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. An energy conversion management system, comprising a battery module, a battery management module, a power control module, and at least one telemetry terminal, wherein,
the battery module is connected to the battery management module, and the battery module is configured to store electric energy and supply power to a load;
the battery management module is connected to the power control module and the telemetry terminal, and the battery management module is configured to perform information acquisition, control and data management on the battery module, transmit battery information to the telemetry terminal and/or the power control module, and simultaneously receive feedback information of the telemetry terminal and/or the power control module;
the power control module is connected to the telemetry terminal, and the power control module is configured to control charging power and discharging power of the battery module according to the battery information transmitted by the battery management module and a control instruction from the telemetry terminal; and
the telemetry terminal is configured to perform data interaction with a user and control the battery management module and the power control module according to a user instruction.

2. The energy conversion management system according to claim 1, further comprising an energy control module, wherein the energy control module is connected to the battery management module, the power control module, a user load, and a power supply, and the energy control module is configured to choose and connect the user load and/or the power supply according to the battery information transmitted by the battery management module and a state of the battery management module.

3. The energy conversion management system according to claim 2, wherein the battery management module comprises an information acquisition unit, a control unit, and a data management unit;
the information acquisition unit is configured to acquire voltage information, temperature information, and current information of the battery module;
the control unit is configured to control charging and discharging of the battery module according to a preset determination condition; and
the data management unit is configured to count a number of charging and discharging cycles of the battery module and charging and discharging electric quantity of the battery module.

4. The energy conversion management system according to claim 3, wherein the control unit is configured to control the charging and discharging of the battery module according to the preset determination condition in the following manners:
acquiring state information of the battery module; and
determining whether a function of the battery module is normal according to the state information, and sending a determination result to the power control module; and
when the function of the battery module is normal, turning on a charging and discharging circuit of the battery module.

5. The energy conversion management system according to claim 3, wherein the energy control module is configured to: when a supply of the power supply is greater than the user load, send a control instruction to the power control module; and the power control module is configured to control the power supply to charge the battery module according to the control instruction from the energy control module; and
the energy control module is configured to: when the supply of the power supply is less than the user load, according to a relationship between a current electricity price queried by the energy control module and a first threshold, control a battery module and/or the power supply to supply power to the user load and control the power supply to charge the battery module.

6. The energy conversion management system according to claim 5, wherein the energy control module is further configured to control the battery module to feed power to the power supply according to a user instruction received by the telemetry terminal.

7. The energy conversion management system according to claim 2, wherein the power control module comprises a DC/DC converter and a DC/AC converter;
the DC/AC converter is configured to: when the battery module is charged to store electric energy, convert an alternating current supplied by the power supply into a direct current and transfer the direct current to the DC/DC converter; and the DC/DC converter is configured to buck the direct current and transfer the bucked direct current to the battery module; and
the DC/DC converter is configured to: when the battery module supplies power to the load, boost a direct current output by the battery module and transfer the boosted direct current to the DC/AC converter; and the DC/AC converter is configured to convert the boosted direct current into an alternating current and transfer the alternating current to the user load.

8. The energy conversion management system according to claim 2, further comprising a wireless module, wherein the energy control module is connected to the telemetry terminal through the wireless module, and the wireless module is configured to wirelessly receive the user instruction.

9. The energy conversion management system according to claim 2, wherein the battery module comprises a single battery or a plurality of battery packs connected in parallel.

10. An energy conversion management method, the method being applied to the energy conversion management system according to claim 1 and comprising:
acquiring battery module information, current electricity price information, user load information, and power supply information;
determining a relationship between a supply of a power supply and a user load and a relationship between a current electricity price and a first threshold; and
controlling charging or discharging of the battery module according to a determination result.

11. The energy conversion management method according to claim 10, wherein the determining a relationship between a supply of a power supply and a user load and a relationship between a current electricity price and a first threshold, comprising:
determining the relationship between a supply of the power supply and the user load;
in response to the supply being greater than or equal to the user load, controlling the power supply to charge the battery module;
in response to the supply being less than the user load, determining the relationship between the current electricity price and the first threshold.

12. The energy conversion management method according to claim 11, wherein the controlling charging or discharging of the battery module according to a determination result, comprising:
in response to the current electricity price being less than the first threshold, controlling the energy conversion management system to access a local power grid for power supply to satisfy a requirement of the user load;
in response to the current electricity price being greater than or equal to the first threshold, controlling the battery module to supply power to the user load.

13. The energy conversion management method according to claim 10, further comprising:
choosing and connecting the user load and/or the power supply according to the battery module information.

14. The energy conversion management method according to claim 13, further comprising:
acquiring voltage information, temperature information, and current information of the battery module;
controlling charging and discharging of the battery module according to a preset determination condition; and
counting a number of charging and discharging cycles of the battery module and charging and discharging electric quantity of the battery module.

15. The energy conversion management method according to claim 14, wherein the controlling charging and discharging of the battery module according to a preset determination condition, comprising:
acquiring state information of the battery module; and
determining whether a function of the battery module is normal according to the state information; and
in response to the function of the battery module being normal, turning on a charging and discharging circuit of the battery module.

16. The energy conversion management method according to claim 13, wherein the power supply is a photovoltaic power supply, the method comprising:
in response to the supply of the photovoltaic power supply being greater than the power required by the user load, connecting the photovoltaic power supply to the user load and controlling the photovoltaic power supply to supply power to the user load;
in response to determining that the function of the battery module is normal according to the state information of the battery module, converting an alternating current provided by a redundant energy of the photovoltaic power supply into a direct current and bucking the direct current to satisfy a charging standard of the battery module and transmitting the bucked direct current to the battery module for charging; and performing over-voltage protection, over-temperature protection, and over-current protection on the battery module, counting charging electric quantity, and disconnecting charging in time after the battery module is fully charged;
in response to determining that the supply of the photovoltaic power supply is insufficient to bear the user load and the charging power of the battery module at the same time, satisfying the power of the user load first and the charging power of the battery module second.

17. The energy conversion management method according to claim 10, further comprising:
when the battery module is charged to store electric energy, converting an alternating current supplied by the power supply into a direct current and bucking the direct current and transferring the bucked direct current to the battery module; and,
when the battery module supplies power to the load, boosting the direct current output by the battery module and converting the boosted direct current into an alternating current and transferring the alternating current to the user load.

18. The energy conversion management method according to claim 10, further comprising:
controlling the battery module to feed power to the power supply according to a user instruction.

19. The energy conversion management method according to claim 18, further comprising:
wirelessly receiving the user instruction.
